(19) United States
(12) Patent Application Publication
(10) Pub. No.: US 2023/0311327 A1
(43) Pub. Date: Oct. 5, 2023

(54) ROBOT CONTROL SYSTEM

(71) Applicant: JOHNAN Corporation, Uji-shi (JP)

(72) Inventors: Kozo MORIYAMA, Uji-shi (JP); Shin KAMEYAMA, Uji-shi (JP); Truong Gia VU, Uji-shi (JP); Lucas BROOKS, Uji-shi (JP)

(73) Assignee: JOHNAN Corporation, Uji-shi (JP)

(21) Appl. No.: 18/180,590

(22) Filed: Mar. 8, 2023

(30) Foreign Application Priority Data
Mar. 29, 2022 (JP) 2022-053296

(51) Int. Cl. B25J 9/16; B25J 13/08; B25J 19/02

(52) U.S. Cl. CPC B25J 9/1682; B25J 9/1666; B25J 9/1697; B25J 9/162; B25J 13/089; B25J 19/023

(57) ABSTRACT

A robot control system according to an embodiment may include: a placement area in which the article is placed; an information providing part that is provided on one of a robot unit including the robot and the placement area and configured to provide information on handling of the article by the robot; an information acquisition part that is provided the other one of the robot unit and the placement area and configured to acquire the information from the information providing part; and a control device configured to control, when the robot handles the article, the robot based on the information acquired by the information acquisition part.

### TECHNICAL FIELD

The disclosure may relate to a robot control system. In particular, the disclosure may relate to measures for enhancing versatility of a robot when the robot handles an article (for example, when the robot transports or processes an article).

### BACKGROUND ART

A robot control system for transporting or otherwise handling an article by a robot is disclosed, for example, in PTL 1. The robot control system disclosed in PTL 1 corrects an action position of a robot when the robot transports an article from a mobile platform to a work cell. The robot is mounted on a mobile platform (an automated guided vehicle, AGV, in PTL 1) and equipped with a CCD camera on a head of the robot. The robot control system executes such correction by scanning, using the CCD camera, the position of a fiducial marker provided on the work cell (a work station in PTL 1) after the mobile platform has stopped, calculating a relative position of the robot to the fiducial marker on the work cell, and thereby correcting the action position of the robot. This robot control system enables a highly precise transport task.

### CITATION LIST

### Patent Literature

PTL 1: JP H01-135485 A

### SUMMARY

However, PTL 1 merely discloses the technique for correcting the action position of the robot in accordance with the relative position of the robot to the work cell. This technique is only applicable to the case where a robot performs a single action (the action to transport the article placed at a particular position on the mobile platform to a particular position on the work cell). The technique disclosed in PTL 1 is not suitable for the case where a robot performs various actions as required and the case where a plurality of robots performs different actions from each other. This technique thus needs improvements in terms of versatility of the robot.

An object of the disclosure may be to provide a robot control system that can ensure enhanced versatility and proper robot control when a robot handles an article.

An aspect of the disclosure is a robot control system for controlling a robot when the robot handles an article. The robot control system includes: a placement area in which the article is placed; an information providing part, provided on one of a robot unit including the robot and the placement area, and configured to provide information on handling of the article by the robot; an information acquisition part, provided the other one of the robot unit and the placement area, and configured to acquire the information from the information providing part; and a control device configured to control the robot when the robot handles the article, based on the information acquired by the information acquisition part.

According to the above described aspect, the information on an action to be performed by the robot when the robot handles the article (an action to be performed by the robot when the robot transports or processes the article) is acquired from the information providing part by the information acquisition part. Based on the acquired information, the control device controls the robot when the robot handles the article. When causing the robot to perform an action as required, the robot control system acquires the information suitable for the action (the required action) from the information providing part by the information acquisition part, for example, at the start of the action. The robot control system can thereby change the action to be performed by the robot each time the robot handles the article. In addition, when causing a plurality of robots to perform different actions from each other, the robot control system acquires different types of information suitable for the respective actions to be performed by the robots, from the information providing part by the information acquisition part. The robot control system can thereby allow the respective robots to perform different actions. As a result, the robot control system can ensure enhanced versatility and proper robot control when one or more robots handle one or more respective articles.

In the robot control system according to the above described aspect, it may be preferable that the robot includes a robot arm configured to transport the article, the information comprises information on any obstacle in the placement area and a periphery thereof, and the control device is configured to control, when the obstacle is present, a trajectory of the robot arm in such a manner as to avoid the obstacle.

With this configuration, when the information acquired from the information providing part contains information indicating the presence of an obstacle in the placement area and the periphery thereof, the trajectory of the robot arm is controlled such that the robot arm can avoid contact with the obstacle. Since the information acquired from the information providing part by the information acquisition part contains obstacle information, the robot control system enables the robot arm to avoid the obstacle, without requiring a special obstacle detector.

In the robot control system according to the above described aspect, it may be preferable that the robot includes a robot arm configured to transport the article, the robot unit includes the robot and a mobile platform on which the robot is mounted, the information acquisition part includes an imaging device that is configured to acquire the information by capturing an image of the information providing part, and the control device is configured to recognize a relative position of the robot unit to the placement area, based on the image of the information providing part captured by the imaging device, and control an action of the robot arm in accordance with the relative position.

When the robot unit has come close to the placement area by the movement of the mobile platform, the stop position of the robot unit needs attention. With the robot unit stopped at a prescribed position, the robot unit activated in accordance with the acquired information can transport the article properly. On the other hand, with the robot unit stopped at a position misaligned from the prescribed position, the robot unit activated in accordance with the acquired information transports the article to a position that is misaligned by the amount of misalignment. In view of such inconvenience, the robot control system according to the above described configuration recognizes a relative position of the robot unit to the placement area, based on the image of the information providing part captured by the imaging device, and controls an action of the robot arm in accordance with the recognized relative position. The robot control system can thereby prevent the article from being transported to a misaligned position. Accordingly, the image of the information providing part is captured by the imaging device that serves as the information acquisition part, and such image-capturing is utilized not only for acquisition of the information on handling of the article by the robot, but also for recognition of the relative position of the robot unit to the placement area. The resulting robot control system can effectively utilize the information acquisition part and the information providing part.

According to the above described aspect, the robot control system is configured to acquire information on the information providing part that is provided on one of the robot unit and the placement area (the information on handling of the article by the robot), by information acquisition part that is provided on the other one of the robot unit and the placement area. The robot control system is further configured to control the robot when the robot handles the article, based on the acquired information. The robot control system can thereby ensure enhanced versatility and proper robot control when the robot handles the article.

### BRIEF DESCRIPTION OF THE DRAWINGS

FIG. 1 is a plan view showing a general configuration of a cellular manufacturing line to which a robot control system according to an embodiment is applied.

FIG. 2 is an illustration showing a general configuration of a first system according to the embodiment.

FIG. 3 is a control block diagram for the first system.

FIG. 4 is an illustration showing a general configuration of a second system according to the embodiment.

FIG. 5 is a control block diagram for the second system.

FIG. 6 is a flowchart for describing the operation of the first system.

FIG. 7 is a flowchart for describing the operation of the second system.

### DESCRIPTION OF EMBODIMENTS

Hereinafter, an embodiment of the disclosure is described with reference to the drawings. In this embodiment, a robot control system is applied to a cellular manufacturing line provided with two robots and two work cells (also called work stations in the following description). Note that the application of the robot control system is not limited to the mode described in this embodiment.

### —Overall Configuration of the Cellular Manufacturing Line—

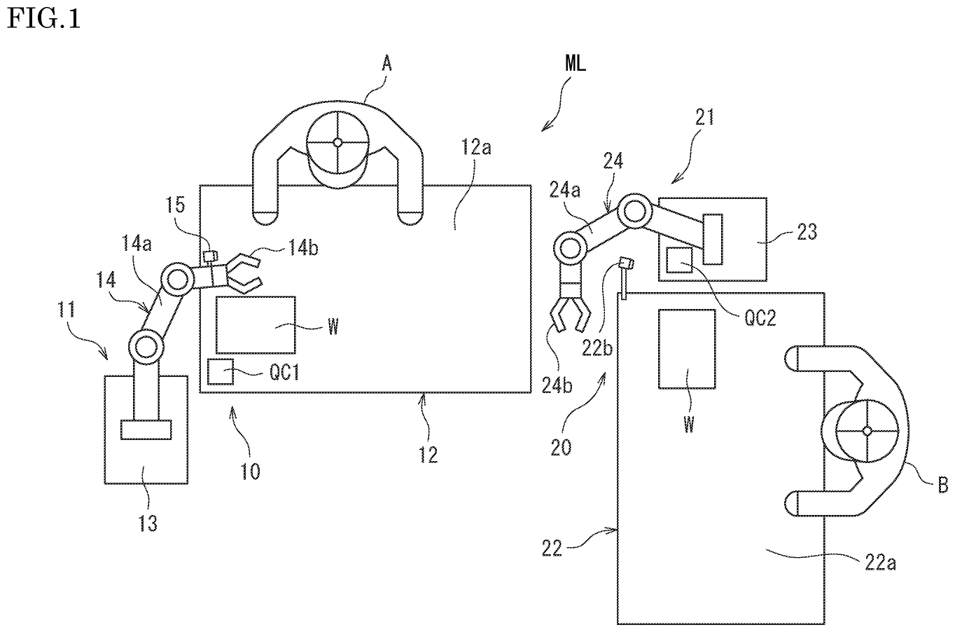

FIG. 1 is a plan view showing a general configuration of a cellular manufacturing line ML to which the robot control system according to an embodiment is applied. As shown in FIG. 1, the cellular manufacturing line ML according to this embodiment includes two robot units (each unit being composed of a mobile platform and a robot mounted thereon) 11, 21 and two work stations 12, 22. The two robot units 11, 21 in this embodiment are a first robot unit 11 on the left of the drawing and a second robot unit 21 on the right thereof. The two work stations 12, 22 are a first work station 12 on the left of the drawing and a second work station 22 on the right thereof.

A manufacture process on the cellular manufacturing line ML in this embodiment includes, for example, following actions. The first robot unit 11 transports a workpiece (an article) W to a predetermined position (a place position) on a top surface 12a of the first work station 12. On the first work station 12, a worker A assembles the workpiece W (assembles a subassembly). The workpiece W is then placed at a predetermined position (a pick position) on the top surface 12a of the first work station 12. The second robot unit 21 transports the workpiece W from the top surface 12a of the first work station 12 to a predetermined position (a place position) on a top surface 22a of the second work station 22. On the second work station 22, a worker B further assembles the workpiece W. Each of the top surfaces 12a, 22a of the work stations 12, 22 corresponds to a placement area (a placement area in which the article is placed).

The robot control system according to this embodiment provides a first system 10 composed of the first robot unit 11 and the first work station 12, and a second system 20 composed of the second robot unit 21 and the second work station 22. These systems 10, 20 are described below.

### —Configuration of the First System—

To start with, the configuration of the first system 10 is described. In this embodiment, the first robot unit 11 that constructs the first system 10 is composed of a mobile platform 13 without a propelling power source (a non-self-propelled hand-guided mobile platform) and a robot 14 mounted thereon. The robot 14 is activated to transport the workpiece W to the first work station 12 (for example, to pick up the workpiece W from a parts box, not shown, and to transport the workpiece W to the first work station 12). The mobile platform 13 may also be an automated guided vehicle (AGV) or an autonomous mobile robot (AMR), each having a propelling power source.

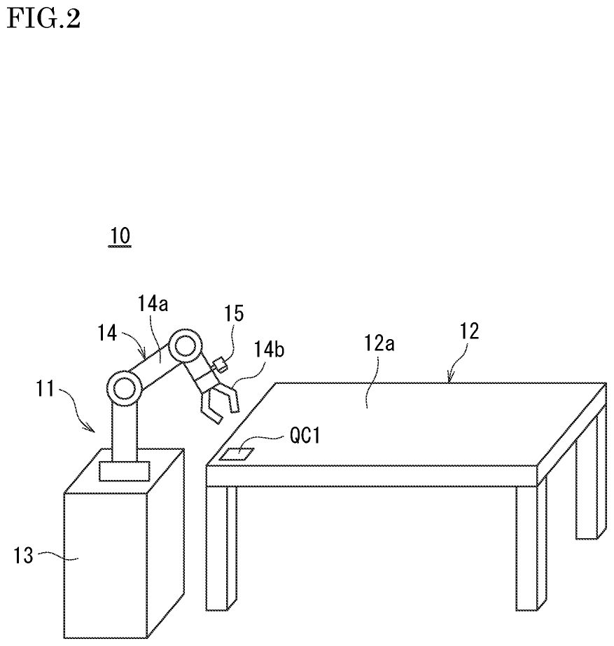

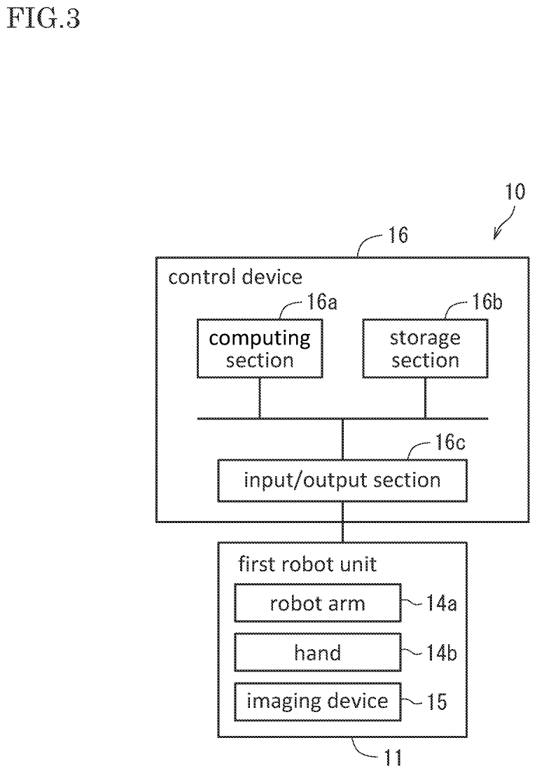

FIG. 2 is an illustration showing a general configuration of the first system 10. FIG. 3 is a control block diagram for the first system 10.

As shown in FIG. 2, the robot 14 has a multi-axis robot arm 14a and a hand 14b, as an end effector, attached to a distal end of the robot arm 14a. The robot arm 14a serves to move the hand 14b to a predetermined position. The hand 14b serves to hold the workpiece W. An imaging device 15 is mounted, as an information acquisition part, on a distal part of the robot arm 14a (near an attachment position of the hand 14b). The imaging device 15 is composed of, for example, an RGB-D camera or the like. The imaging device 15 serves to capture an image of the top surface 12a of the first work station 12 and a periphery of the first work station 12, and to output information on the captured image to a control device 16 (see FIG. 3). The information on the image captured by the imaging device 15 serves as information for recognizing the place position of the workpiece W on the top surface 12a of the first work station 12. The image information also serves as information scanned from a QR code QC1. As described below, the QR code QC1 is provided (affixed) on the top surface 12a of the first work station 12 and serves as an information providing part. The information providing part is not limited to the QR code QC1 and may be an AR marker. The information acquired through scanning of the QR code QC1 or the AR marker by the imaging device 15 is either information contained in (retrieved from) the QR code QC1 or the AR marker, or information stored in advance in a personal computer, etc. (for example, a storage section 16b, etc., to be described later) and identified by the retrieved information.

The first work station 12 is a table where the worker A assembles the workpiece W. The QR code QC1 is provided at a corner of the top surface 12a (in FIG. 2, a near-side corner on the left). The QR code QC1 contains information on a work step for the robot 14 in the first robot unit 11 (a step for transporting the workpiece W). The work step information can be acquired through the scanning of the QR code QC1 by the imaging device 15. The work step information corresponds to information on handling of the article by the robot. Specifically, following types of information are acquired when the QR code QC1 is scanned by the imaging device 15, for example:
information on the place position of the workpiece W on the top surface 12a of the first work station 12
   information on the size and orientation of the top surface 12a of the first work station 12
   information on any obstacle on the top surface 12a of the first work station 12 and the periphery thereof
   information on a collaboration task, when the robot 14 in the first robot unit 11 collaborates with the worker A at the first work station 12

As shown in FIG. 3, the control device 16 for controlling the robot 14 serves as a control system for the first system 10. The control device 16 is configured by a computer that includes a computing section (a processor such as a CPU) 16a, a storage section (a ROM, etc.) 16b, and an input/output section 16c.

The computing section 16a executes arithmetic processing based on, for example, a program (an operating program) stored in the storage section 16b, and thereby calculates control command information for controlling the robot 14.

The storage section 16b stores, for example, an operating program for controlling the robot 14. The operating program in this embodiment includes: a base program for controlling the robot 14 in accordance with the information scanned from the QR code QC1 (including the information on the place position of the workpiece W on the top surface 12a of the first work station 12); and a correction program for correcting a controlled variable obtained for the robot 14 by the base program, as described below. The operating program, constructed with the base program and the correction program in this embodiment, is not limited to this disclosure.

The base program serves to obtain trajectories of the robot arm 14a and the hand 14b when the robot 14 is controlled according to the information scanned from the QR code QC1 (when the robot 14 transports the workpiece W to a predetermined position on the top surface 12a of the first work station 12), for example, in such a manner as to substantially minimize a transport distance of the workpiece W to the predetermined position on the top surface 12a.

The correction program (the program for correcting the controlled variable obtained by the base program for the robot 14) serves to correct the trajectories of the robot arm 14a and the hand 14b, according to obstacle avoidance data and relative position correction data.

The correction program for obstacle avoidance serves to determine a correction variable to the controlled variable for the robot 14 (the controlled variable obtained by the base program) when the information scanned from the QR code QC1 contains the information indicating the presence of an obstacle, in such a manner that the trajectories of the robot arm 14a and the hand 14b can avoid the obstacle. For example, the information scanned from the QR code QC1 contains three-dimensional position information on the obstacle (information on three-dimensional position coordinates of the obstacle), in which case the correction variable to the controlled variable for the robot 14 is determined such that the trajectories of the robot arm 14a and the hand 14b (three-dimensional positions of the robot arm 14a and the hand 14b on the trajectories) do not interfere with the three-dimensional position of the obstacle. The three-dimensional position information on the obstacle is written in advance in the QR code QC1, in accordance with a layout of the cellular manufacturing line ML and the like.

The correction program for relative position correction serves to correct the position information for transporting the workpiece W to the predetermined position on the top surface 12a of the first work station 12 (the predetermined place position), in accordance with the relative position of the first robot unit 11 (more specifically, the robot 14) to the top surface 12a of the first work station 12. The relative position of the robot 14 to the top surface 12a of the first work station 12 is obtained using the image scanned from the QR code QC1 by the imaging device 15. To be specific, with the posture of the robot arm 14a being the same, an image of the QR code QC1 captured by the imaging device 15 on the presumption that the first robot unit 11 is stopped at a prescribed position is compared with an image of the QR code QC1 actually captured by the imaging device 15. If these images are misaligned from each other, the stop position of the first robot unit 11 can be judged as misaligned. Using this misalignment of the images, it is possible to obtain the relative position of the robot 14 to the top surface 12a of the first work station 12. To give an example, it is possible to judge that the position of the mobile platform 13 relative to the first work station 12 (the position of the mobile platform 13 manually pushed and stopped by the worker) is misaligned to the near side (to the bottom in FIG. 1), by referring to the image of the QR code QC1 actually captured by the imaging device 15. In this case, the robot arm 14a is controlled to correct the position of the hand 14b to the far side (to the top in FIG. 1) (the place position is corrected to the far side). Consequently, even when the position of the mobile platform 13 is misaligned, the workpiece W can be transported to the predetermined position on the top surface 12a of the first work station 12.

The input/output section 16c is connected with the first robot unit 11. The input/output section 16c can receive, from the first robot unit 11, the work step information acquired through the scanning of the QR code QC1 by the imaging device 15. The input/output section 16c can also transmit the control command information to the first robot unit 11.

—Configuration of the second system—

Next, the configuration of the second system 20 is described. In this embodiment, the second robot unit 21 that constructs the second system 20 is composed of a self-propelled mobile platform 23 with a propelling power source and a robot 24 mounted thereon. The robot 24 is activated to transport the workpiece W from the first work station 12 to the second work station 22. The mobile platform 23 is an AGV or an AMR.

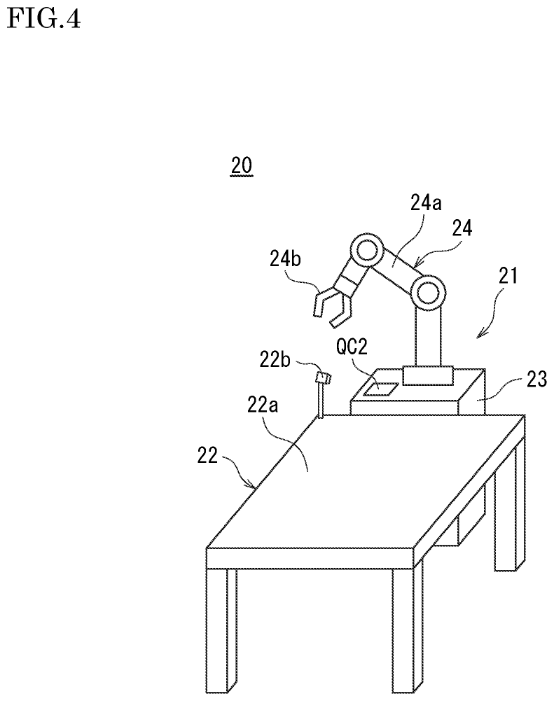

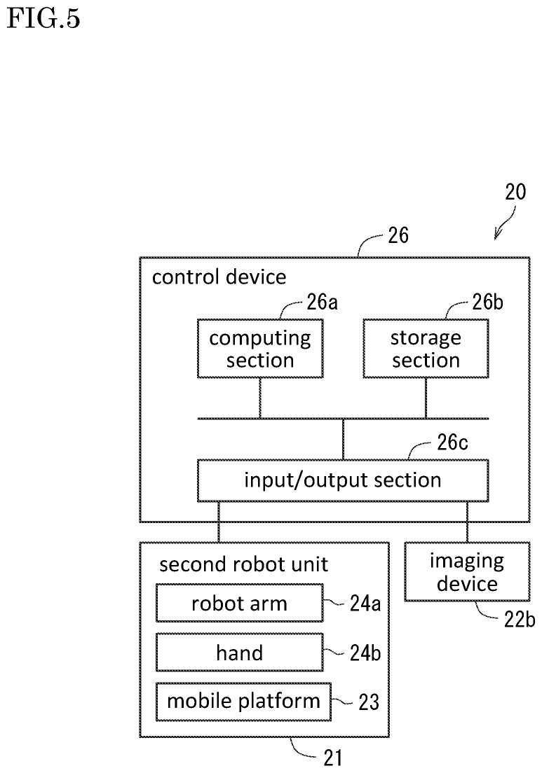

FIG. 4 is an illustration showing a general configuration of the second system 20. FIG. 5 is a control block diagram for the second system 20.

As shown in FIG. 4, the robot 24 has a multi-axis robot arm 24a and a hand 24b, just as the robot 14 in the first system 10.

The second work station 22 is a table where the worker B assembles the workpiece W. An imaging device 22b is provided at a corner of the top surface 22a of the second work station 22 (in FIG. 4, a far-side corner on the left). The imaging device 22b is composed of, for example, an RGB-D camera or the like. The imaging device 22b serves to capture an image of a top surface of the mobile platform 23 in the second robot unit 21 and a periphery of the mobile platform 23, and to output information on the captured image to a control device 26 (see FIG. 5). The information on the image captured by the imaging device 22b serves as information scanned from a QR code QC2. As described below, the QR code QC2 is provided on the top surface of the mobile platform 23 and serves as the information providing part. Also in the second system 20, the information providing part is not limited to the QR code QC2 and may be an AR marker. The information acquired through scanning of the QR code QC2 or the AR marker by the imaging device 22b is either information contained in (retrieved from) the QR code QC2 or the AR marker, or information stored in advance in a personal computer, etc. (for example, a storage section 26b, etc., to be described later) and identified by the retrieved information.

The QR code QC2 is provided on the top surface of the mobile platform 23. The QR code QC2 contains information on respective work steps for the mobile platform 23 and the robot 24 in the second robot unit 21. The work step information can be acquired through the scanning of the QR code QC2 by the imaging device 22b. The work step information corresponds to information on handling of the article by the robot. Specifically, following types of information are acquired when the QR code QC2 is scanned by the imaging device 22b, for example:
information on the pick position of the workpiece W on the top surface 12a of the first work station 12
   information on the place position of the workpiece W on the top surface 22a of the second work station 22
   information on the size and orientation of the top surface 22a of the second work station 22
   information on any obstacle on the top surface 22a of the second work station 22 and the periphery thereof
   information on a collaboration task, when the robot 24 in the second robot unit 21 collaborates with the worker B at the second work station 22

As shown in FIG. 5, the control device 26 for controlling the robot 24 serves as a control system for the second system 20. Similar to the above-described control device 16 in the first system 10, the control device 26 includes a computing section 26a, a storage section 26b, and an input/output section 26c. A difference from the above-described control device 16 in the first system 10 is found in the storage section 26b that stores, for example, an operating program for controlling the robot 24. The operating program in this embodiment includes: a base program for controlling the robot 24 in accordance with the information scanned from the QR code QC2 (including the information on the pick position of the workpiece W on the top surface 12a of the first work station 12, and the information on the place position of the workpiece W on the top surface 22a of the second work station 22); and a correction program for correcting a controlled variable obtained for the robot 24 by the base program. As described above, the correction program serves to correct the controlled variable in the same manner as in the first system 10, based on the obstacle information and the information on the relative position of the robot 24 to the top surfaces 12a, 22a of the work stations 12, 22.

The base program serves to obtain trajectories of the robot arm 24a and the hand 24b when the robot 24 is controlled according to the information scanned from the QR code QC2 (when the robot 24 transports the workpiece W from the predetermined position on the top surface 12a of the first work station 12 to the predetermined position on the top surface 22a of the second work station 22), for example, in such a manner as to minimize a transport distance of the workpiece W to the predetermined position on the top surface 22a.

The correction program includes, as described above, the correction program for obstacle avoidance and the correction program for relative position correction.

The correction program for obstacle avoidance serves to determine a correction variable to the controlled variable for the robot 24 (the controlled variable obtained by the base program) when the information scanned from the QR code QC2 contains the information indicating the presence of an obstacle, in such a manner that the trajectories of the robot arm 24a and the hand 24b can avoid the obstacle.

The correction program for relative position correction serves to correct the position information for transporting the workpiece W from the predetermined position on the top surface 12a of the first work station 12 (the predetermined pick position) to the predetermined position on the top surface 22a of the second work station 22 (the predetermined place position), in accordance with the relative position of the second robot unit 21 (more specifically, the robot 24) to the top surface 12a of the first work station 12 and the relative position of the robot 24 to the top surface 22a of the second work station 22. The relative positions of the robot 24 to the top surfaces 12a, 22a of the respective work stations 12, 22 are obtained using the image scanned from the QR code QC2 by the imaging device 22b. These relative positions can be obtained by the same principle as in the first system above. Consequently, even when the position of the mobile platform 23 is misaligned relative to either or both of the work stations 12, 22, the workpiece W can be transported from the predetermined position on the top surface 12a of the first work station 12 to the predetermined position on the top surface 22a of the second work station 22.

The input/output section 26c is connected with the second robot unit 21 and the imaging device 22b. The input/output section 26c can receive, from the imaging device 22b, the work step information acquired through the scanning of the QR code QC2 by the imaging device 22b. The input/output section 26c can also transmit the control command information to the second robot unit 21.

—Operation of the robot control system—

The description turns to the operation of the robot control system (the first system 10 and the second system 20) configured as above.

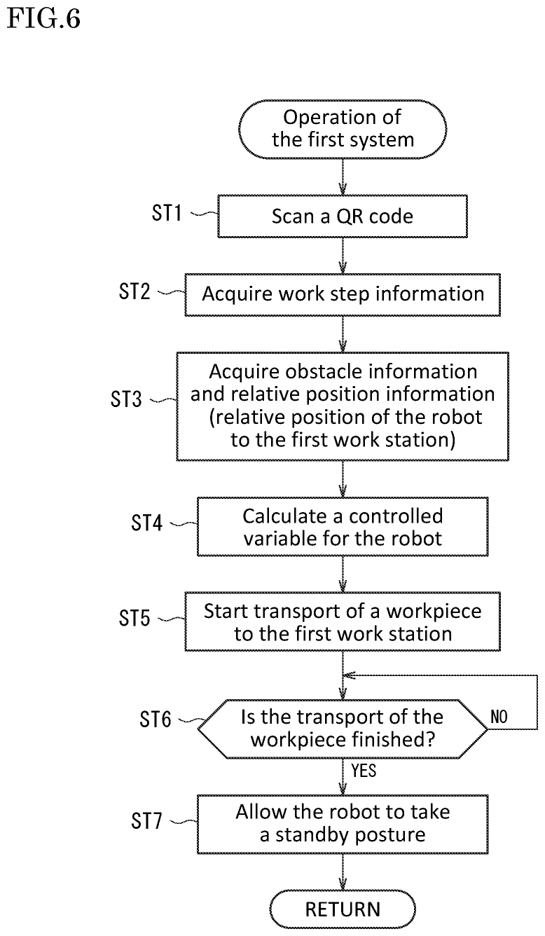

FIG. 6 is a flowchart for describing the operation of the first system 10. The operation in this flowchart is repeated every time a place request for placing the workpiece W on the first work station 12 is received.

Referring to FIG. 6, when the first system 10 starts to operate, the QR code QC1 is scanned by the imaging device 15 in step ST1. The scanning process includes capturing an image of the top surface of the first work station 12 and the periphery of the first work station 12 by the imaging device 15, thereby recognizing the position of the QR code QC1, and then activating the robot arm 14a to bring the imaging device 15 closer to the recognized position of the QR code QC1.

In step ST2, the first system 10 acquires the above-described information (the work step information) from the scanned QR code QC1.

In step ST3, the first system 10 acquires obstacle information (information on the presence/absence of an obstacle and, if any, position information on the obstacle) contained in the scanned information. The first system 10 also acquires the information on the relative position of the robot 14 to the first work station 12 (information on the amount of misalignment, when the relative position of the robot 14 to the first work station 12 is misaligned), based on the image of the QR code QC1 (an appearance of the QR code QC1).

In step ST4, the first system 10 calculates a controlled variable for the robot 14, based on the acquired information. As described above, the controlled variable is obtained in such a manner that the trajectories of the robot arm 14a and the hand 14b avoid the obstacle and in consideration of the misalignment of the relative position of the robot 14 to the first work station 12.

In step ST5, the first system 10 starts to control the robot 14, using the calculated controlled variable, and starts to transport the workpiece W to the first work station 12.

In step ST6, the first system 10 determines whether the transport of the workpiece W to the first work station 12 is finished.

When the determination in step ST6 is YES, namely, when the transport of the workpiece W to the first work station 12 is finished, the process goes step ST7. In step ST7, the robot 14 is allowed to take a standby posture, and the process returns thereafter. This operation is repeated every time the place request for placing the workpiece W on the first work station 12 is received.

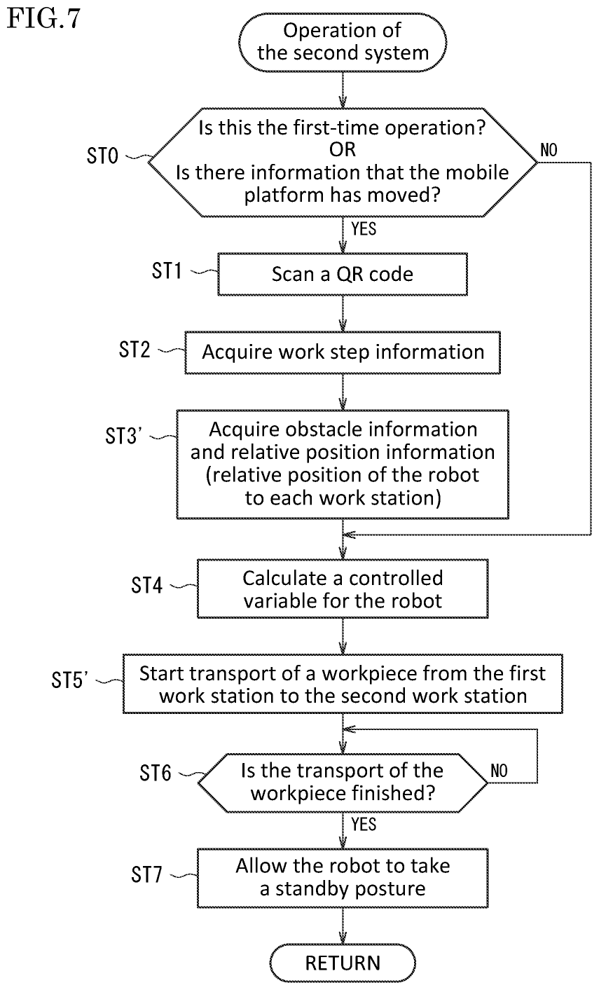

The description turns next to the operation of the second system 20. FIG. 7 is a flowchart for describing the operation of the second system 20. The operation in this flowchart is repeated every time a transport request for transporting the workpiece W from the first work station 12 to the second work station 22 is received. In this flowchart, the steps identical to those in the first system 10 are indicated by the same step numbers.

When the second system 20 starts to operate, step ST0 is executed to determine whether the second system 20 operates for the first time (when a newly constructed cellular manufacturing line ML starts manufacturing) or whether there is information that the mobile platform 23 has moved. In the case where the second system 20 operates for the first time or where the mobile platform 23 has moved, there is a possibility that the operation to be executed by the second system 20 has been changed or the position of the second robot unit 21 relative to the work stations 12, 22 has been changed. Such changes necessitate scanning of the QR code QC2. To put it simply, step ST0 is executed to determine whether the QR code QC2 needs scanning.

When the determination in step ST0 is YES, the process goes to step ST1, where the QR code QC2 is scanned by the imaging device 22b. After the work step information is acquired in step ST2, the process goes to step ST3′. In step ST3′, the second system 20 acquires obstacle information contained in the scanned information. The second system 20 also acquires the information on the relative positions of the robot 24 to the work stations 12, 22, based on the image of the QR code QC2 (an appearance of the QR code QC2). Thereafter, the process goes to step ST4.

When the determination in step ST0 is NO, the second system 20 judges that the information to be acquired through the scanning of the QR code QC2 has been already acquired in a previous routine. Thereafter, the process goes to step ST4.

In step ST4, the second system 20 calculates a controlled variable for the robot 24, based on the acquired information. In step ST5′, the second system 20 starts to control the robot 24, using the calculated controlled variable, and starts to transport the workpiece W from the first work station 12 to the second work station 22.

In step ST6, the second system 20 determines whether the transport of the workpiece W to the second work station 22 is finished. When the determination in step ST6 is YES, namely, when the transport of the workpiece W to the second work station 22 is finished, the process goes step ST7. In step ST7, the robot 24 is allowed to take a standby posture, and the process returns thereafter. This operation is repeated every time the transport request for transporting the workpiece W from the first work station 12 to the second work station 22 is received.

### Advantageous Effects of the Embodiment

As described above, the robot control system according to this embodiment acquires the information on the transport of the workpiece W by the robots 14, 24 (information on the steps relating to the transport) from the QR codes QC1, QC2 by using the imaging devices 15, 22b. Based on the acquired information, the robot control system controls the robots 14, 24 independently so as to enable their respective transport operations. The robot control system can thus ensure enhanced versatility and proper robot control when each of the robots 14, 24 transports the workpiece W.

Further, the robot control system according to this embodiment corrects (controls) the trajectories of the robot arms 14a, 24a and the hands 14b, 24b, when the information scanned from the QR codes QC1, QC2 includes information indicating the presence of an obstacle. The trajectories are corrected such that the robot arms 14a, 24a and the hands 14b, 24b can avoid contact with the obstacle. Since the information acquired from the QR codes QC1, QC2 by the imaging devices 15, 22b contains obstacle information, the robot control system enables the robot arm 14a, 24a and the hand 14b, 24b to avoid the obstacle, without requiring a special obstacle detector.

Further, the robot control system according to this embodiment obtains the amount of misalignment of the robot units 11, 21 relative to the work stations 12, 22, based on the images of the QR codes QC1, QC2 captured by the imaging devices 15, 22b. The robot control system controls the actions of the robot arms 14a, 24a in accordance with the amount of misalignment. This embodiment can thereby prevent the workpiece W from being transported to a misaligned position. Furthermore, the capturing of the images of the QR codes QC1, QC2 by the imaging devices 15, 22b is utilized not only for acquisition of the information on the transport of the workpiece W but also for recognition of the relative positions of the robot units 11, 21 to the work stations 12, 22. This embodiment can effectively utilize the imaging devices 15, 22b and the QR codes QC1, QC2.

### Other Embodiments

It should be noted that the embodiment disclosed herein is considered in all respects as illustrative and should not be taken as a basis for any restrictive interpretation. Therefore, the technical scope of the invention should not be construed by the above-described embodiment alone, but should be defined on the basis of the recitation in the claims. The technical scope of the invention encompasses all variations and modifications being equivalent to and falling within the equivalency range of the appended claims.

For example, the above embodiment describes the example of transporting the workpiece W by the robots 14, 24 in the cellular manufacturing line ML, but this is not a limitative example. Alternatively, the robots 14, 24 may process or otherwise handle the workpiece W. To be more specific, the above embodiment describes the example of the robots 14, 24 having the robot arms 14a, 24a and the hands 14b, 24b, but the structure of the robots 14, 24 is not limited thereto and may be arranged freely. Additionally, the robots 14, 24 are not limited to so-called industrial robots applied to the cellular manufacturing line ML, and may be, for example, so-called service robots applied to catering service in restaurants, etc.

Further in the above embodiment, the robot units 11, 21 are composed of the mobile platforms 13, 23 and the robots 14, 24 mounted thereon. The robot unit in the invention is not limited thereto, and may be composed of a stationary robot that is not mounted on a mobile platform.

Further in the above embodiment, the QR codes QC1, QC2 serve as the information providing part, and the imaging devices 15, 22b serve as the information acquisition part. The invention is not limited to this disclosure. Alternatively, the information providing part may be an IC tag such as an RF tag, and the information acquisition part may be a tag reader.

The part or device for recognizing the relative positions of the robot units 11, 21 to the work stations 12, 22 may also be ranging sensors, etc.

Further in the above embodiment, the imaging device 15 in the first system 10 is provided on the robot arm 14a, but may be provided on the mobile platform 13 instead. Further in the above embodiment, the QR code QC2 in the second system 20 is provided on the mobile platform 23, but may be provided on the robot arm 24a instead.

Further in the above embodiment, acquisition of the information from the QR codes QC1, QC2 and acquisition of the peripheral images are both achieved through the image-capturing by the imaging devices 15, 22b. Alternatively, an imaging device for acquisition of the information and an imaging device for acquisition of the peripheral image may be provided separately.

### INDUSTRIAL APPLICABILITY

The disclosure is applicable to a robot control system in which a robot transports or otherwise handles an article.

### REFERENCE SIGNS LIST

10 first system (robot control system)
11 first robot unit
12a top surface of the first work station (placement area)
20 second system (robot control system)
21 second robot unit
22a top surface of the second work station (placement area)
13, 23 mobile platforms
14, 24 robots
14a, 24a robot arms
15, 22b imaging devices (information acquisition part)
16, 26 control devices
W workpiece (article)
QC1, QC2 QR codes (information providing part)

What is claimed is:

1. A robot control system for controlling a robot when the robot handles an article, the robot control system comprising:
a placement area in which the article is placed;
an information providing part, provided on one of a robot unit including the robot and the placement area, and configured to provide information on handling of the article by the robot;
an information acquisition part, provided the other one of the robot unit and the placement area, and configured to acquire the information from the information providing part; and
a control device configured to control the robot when the robot handles the article, based on the information acquired by the information acquisition part.

2. The robot control system according to claim 1, wherein the robot comprises a robot arm configured to transport the article,
the information comprises information on any obstacle in the placement area and a periphery thereof, and
the control device is configured to control, when the obstacle is present, a trajectory of the robot arm in such a manner as to avoid the obstacle.

3. The robot control system according to claim 1, wherein
the robot comprises a robot arm configured to transport the article,
the robot unit comprises the robot and a mobile platform on which the robot is mounted,
the information acquisition part comprises an imaging device that configured to acquire the information by capturing an image of the information providing part, and
the control device is configured to recognize a relative position of the robot unit to the placement area, based on the image of the information providing part captured by the imaging device, and control an action of the robot arm in accordance with the relative position.
